(19) United States
(12) Patent Application Publication
(10) Pub. No.: US 2006/0271629 A1
(43) Pub. Date: Nov. 30, 2006

(54) Distributed Challenge and Response Recognition System

(76) Inventor: Alexander Donald MacDowell, Des Peres, MO (US)

Correspondence Address: JEFFREY FURR, 253 N. MAIN STREET, JOHNSTOWN, OH, 43031, US

(21) Appl. No.: 10/908,778

(22) Filed: May 26, 2005

(51) Int. Cl. G06F 15/16

(52) U.S. Cl. 709/206; 709/229

(57) ABSTRACT

A computer system and method for filtering unauthorized electronic mail messages that are sent by senders to a user. The firewall intercepts any incoming email sent to the user and checks it against a master list of allowed senders. Any sender not found on the list is sent a user-configurable challenge that must be responded to within a set time limit. If the challenge is not successfully met, the sender can be blocked and the mail can be bounced, discarded, or sent a removal request.

### 1. FIELD OF THE INVENTION

This invention relates generally to electronic mail systems and more particularly to the filtering of electronic mail messages with a unique, distributed challenge, and response based email firewall.

### 2. DESCRIPTION OF PRIOR ART

Electronic mail is an increasingly popular form of communication and almost mission critical to many businesses. Electronic mail systems allow a sender who is one user of a computer system to send an electronic message to another user who is a recipient. The sender designates the recipient to whom the electronic mail is to be sent and creates the body of the electronic mail message. The electronic mail system then forwards the electronic mail message to the recipient via a communications mechanism such as a local area network or the Internet. When the recipient receives the electronic mail messages, the recipient can view the body of the electronic mail message.

In the past, a user of an electronic mail system generally received electronic mail messages only from known senders. Many of these would be done within a single company or business. An employee of a company would receive electronic mail messages only from other employees of the company. The electronic mail system would only be connected to computer systems owned by the company. However, with the increasing popularity of the Internet and the global workplace, a user may be able to send electronic mail messages to anyone who is connected to the Internet. The sender of an electronic mail message needs only to know the electronic mail address of the recipient. Thus, users can and often do receive electronic mail messages from unknown senders.

Recently, a problem has developed which seriously impairs the effectiveness of electronic mail systems. Many promotional companies are turning to the Internet to advertise products of their clients. These promotional companies acquire and maintain lists of electronic mail addresses for thousands of users. When a client wants to advertise a product, the promotional company will send an electronic mail message to each electronic mail address in its list. A user usually now receives unsolicited electronic mail message from such promotional companies.

Promotional companies also use algorithms to come up with potential E-mail addresses by combining known E-mail address formats and using these addresses to send E-mails to users who have never even given their E-mail address out.

Because of the perceived benefits of advertising via the Internet on the low costs of doing so, a user may now receive so many unsolicited electronic mail messages that many times the unsolicited electronic mail messages vastly outnumber the electronic mails messages received from known senders. The process of sending these vast number of promotional electronic mail messages indiscriminately to the various electronic mail addresses by the promotional companies is referred to as “spamming.” It has been a serious impediment to the effectiveness of the electronic mail systems. The seriousness of the problem has been recognized and legislation has even been proposed and passed that would outlaw such spamming practices.

The term “spam” has come to refer to posting electronic messages to news groups or mailing to addresses on an address list the same message an unacceptably large number of times. As used herein, the term “spam” or “junk mail” refers to the sending of unsolicited electronic messages to a large number of users. This includes email advertisements, sometimes referred to as Unsolicited Commercial Email (UCE), as well as non-commercial bulk email that advocate some political or social position. A “spammer” is a person or organization that generates the junk mail.

Spam can also be a serious security problem. For instance, the Melissa virus and ExploreZip.worm have been spread almost exclusively via email attachments. Such viruses are usually dangerous only if the user opens the attachment that contains the malicious code, but many users open such attachments either accidentally or not knowing the danger.

Email may also be used to download or activate dangerous code, such as Java applets, Javascript, and ActiveX controls. Email programs that support Hypertext Markup Language (HTML) can download malicious Java applets or scripts that execute with the mail user's privileges and permissions. Email has also been used to activate certain powerful ActiveX controls that were distributed with certain operating systems and browsers. In this case, the code is already on the user's system, but is invoked in a way that is dangerous such as installing a computer virus, turning off security checking, or to reading, modifying, or deleting any information on the user's computer system or network.

Both spammers and those who produce malicious code, typically attempt to hide their identities when they distribute mail or code. Instead of mailing directly from an easily traced account at a major Internet provider, they may for instance, send their mail from a spam-friendly network, using forged headers or relay the message through intermediate hosts. The spammers are now even hijacking and stealing other people's E-mail addresses and computer systems using Trojan horses and using them to send spam. Consequently, the same mechanisms that can be used to block spam can also be used to provide a layer of protection for keeping malicious code out of an organization's internal network.

The current anti-spam technologies such as OCR and Session ID URLs rely on one form of server generated authentication to presumably stop spam, but as only the output is random and not the method of authentication, these technologies can be cracked/automated with a 100% success rate given a small amount of programming knowledge.

Prior Art

There have been many attempts to prevent spamming. These have met with moderate success. U.S. Pat. No. 6,321,267 uses an Active Filtering proxy which filters electronic junk mail received at a Message Transfer Agent from remote Internet hosts using the Simple Mail Transfer Protocol (SMTP).

U.S. Pat. No. 6,023,723 filed by McCormick, uses a method of filtering junk e-mails while the user is provided with or compiles a list of e-mail addresses or character strings which the user would not wish to receive to produce a first filter. A second filter is provided including names and character strings which the user wishes to receive.

U.S. Pat. No. 5,999,932 filed by Paul and issued on Dec. 7, 1999 is for a “System and method for filtering unsolicited electronic mail messages using data matching and heuristic processing.” It discloses a system for eliminating unsolicited electronic mail that generates and stores a user inclusion list including identification data for identifying e-mail desired by the user.

U.S. Pat. No. 5,619,648 by Canale uses an e-mail filter which has access to information which provides a model of the user. The e-mail filter uses the non-address information and the model information to determine whether the e-mail message should be provided to the user.

United States Patent U.S. Pat. No. 5,283,856 by Gross uses a rule mechanism that is implemented having a “When-If-Then” event-driven, conditional, action-invoking paradigm or “triplet” which permits definition of a repertoire of events considered to be significant events upon which to trigger actions in the electronic mail messaging system.

There have been ideas dealing with the charging of E-mail messages based on the size of the message. U.S. Pat. No. 6,199,054 by Khan uses a system that monitors a data payload that is being transmitted in a secure form over the Internet and provides rate computations for such payloads based on the size of the data with the data container that may be implemented as a digital envelope with the bitmap (digital picture) of a stamp. U.S. Pat. No. 5,771,289 by Kuzma uses a method and apparatus for transmitting electronic messages wherein payment is required for the transmission. Payment is made as messages are transmitted using previously obtained electronic stamps or credits. These methods are not designed to prevent spamming.

The need for a better method for preventing the spamming of E-mail addresses that is accurate, quick, inexpensive, and easy to use shows that there is still room for improvement within the art.

### SUMMARY OF THE INVENTION

The object of the present invention is to provide a method to a computer system and method for filtering unauthorized messages that are received by a user. The system's firewall intercepts any incoming email sent to the user and checks it against a master list of allowed senders. Any sender not found on the list is sent a user configurable challenge that must be responded to within a set time limit. If the challenge is not successfully met, the sender can be blocked and the mail can be bounced, discarded, or sent a removal request.

Current anti-spam technologies such as OCR and Session ID URLs rely on one form of server generated authentication to presumably stop spam—however, as only the output is random and not the method of authentication, these technologies can cracked/automated with a 100% success rate given a small amount of programming knowledge.

The distributed challenge and response recognition system requires no central server. It uses a user-run client and allows for any type of user set challenge. Challenges include, but are not limited to: true/false questions, multiple-choice questions, fill in the blank, simple Q&A, active puzzles and picture recognition. As the user can define his or her own unique challenge, based literally upon any source with any possible answer, there is no known method of automating or cracking the authentication protocol. It is possible that many users will have similar or same questions and answers, example, if 1000s of people use “what state do I live in?” or “what is my favorite color?” There will be quite a bit of overlapping, but the spam protection is still to the point that it is not financially or otherwise beneficial for a spammer sending out millions of emails only to be able to guess correct answers on a few similar questions.

This is the only system that allows each user to have an individual, unique and personalized challenge. There are no limits as to what can be used for a challenge making for endless challenges and answers that are impossible to automate.

The process is more efficient, effective, and functional than the current art.

Glossary of Terms

Browser: a software program that runs on a client host and is used to request Web pages and other data from server hosts. This data can be downloaded to the client's disk or displayed on the screen by the browser.

Client host: a computer that requests Web pages from server hosts, and generally communicates through a browser program.

Content provider: a person responsible for providing the information that makes up a collection of Web pages.

Embedded client software programs: software programs that comprise part of a Web site and that get downloaded into, and executed by, the browser.

Cookies: data blocks that are transmitted to a client browser by a web site.

Hit: the event of a browser requesting a single Web component.

Host: a computer that is connected to a network such as the Internet. Every host has a hostname (e.g., mypc.mycompany.com) and a numeric IP address (e.g., 123.104.35.12).

HTML (HyperText Markup Language): the language used to author Web Pages. In its

raw form, HTML looks like normal text, interspersed with formatting commands. A browser's primary function is to read and render HTML.

HTTP (HyperText Transfer Protocol): protocol used between a browser and a Web server to exchange Web pages and other data over the Internet.

HyperText: text annotated with links to other Web pages (e.g., HTML).

IP (Internet Protocol): the communication protocol governing the Internet.

Server host: a computer on the Internet that hands out Web pages through a Web server program.

URL (Uniform Resource Locator): the address of a Web component or other data. The URL identifies the protocol used to communicate with the server host, the IP address of the server host, and the location of the requested data on the server host. For example, “http://www.lucent.com/work.html” specifies an HTTP connection with the server host www.lucent.com, from which is requested the Web page (HTML file) work.html.

UWU server: in connection with the present invention, a special Web server in charge of distributing statistics describing Web traffic.

Visit: a series of requests to a fixed Web server by a single person (through a browser), occurring contiguously in time.

Web master: the (typically, technically trained) person in charge of keeping a host server and Web server program running.

Web page: multimedia information on a Web site. A Web page is typically an HTML document comprising other Web components, such as images.

Web server: a software program running on a server host, for handing out Web pages.

Web site: a collection of Web pages residing on one or multiple server hosts and accessible through the same hostname (such as, for example, www.lucent.com).

### BRIEF DESCRIPTION OF THE DRAWINGS

Without restricting the full scope of this invention, the preferred form of this invention is illustrated in the following drawings:

FIG. 1 shows an overview of how a User sends and receives E-mail;

FIG. 2 shows a sample of a how E-mail messages are Spammed;

FIG. 3 shows how in the previous art how Spammed E-mail fills up the Users inbox;

FIG. 4 shows the prior art anti-spam software flow chart;

FIG. 5 shows the system's anti-spam flow chart; and

FIG. 6 shows how multiple users use the system.

### DESCRIPTION OF THE PREFERRED EMBODIMENT

Below is the preferred embodiment of the current invention, but it is not the only embodiment of the current invention and should not be read as such.

The current invention is a unique, distributed, challenge and response based email firewall.

Electronic mail is an increasingly popular form of communications. Electronic mail systems allow one sender a user of a computer system to send a message electronically to another user, a recipient. To create an electronic mail message, the sender designates the recipient to whom the electronic mail is to be sent and creates the body of the electronic mail message. The electronic mail system then forwards the electronic mail message to the recipient via a communications mechanism like a local area network or the Internet.

The problem of the receiving of Spam mail has developed which seriously impairs the effectiveness of electronic mail systems. The process of sending these promotional electronic mail messages indiscriminately to the various electronic mail addresses by the promotional companies is referred to as “spamming.” It has been a serious impediment to the effectiveness of the electronic mail systems.

The System 1 is a computer system and method for filtering unauthorized messages that are received by a user. The system's firewall intercepts any incoming email sent to the user and checks it against a master list of allowed senders. Any sender not found on the list is sent a user configurable challenge that must be responded to within a set time limit. If the challenge is not successfully met, the sender can be blocked and the mail can be bounced, discarded, or sent a removal request.

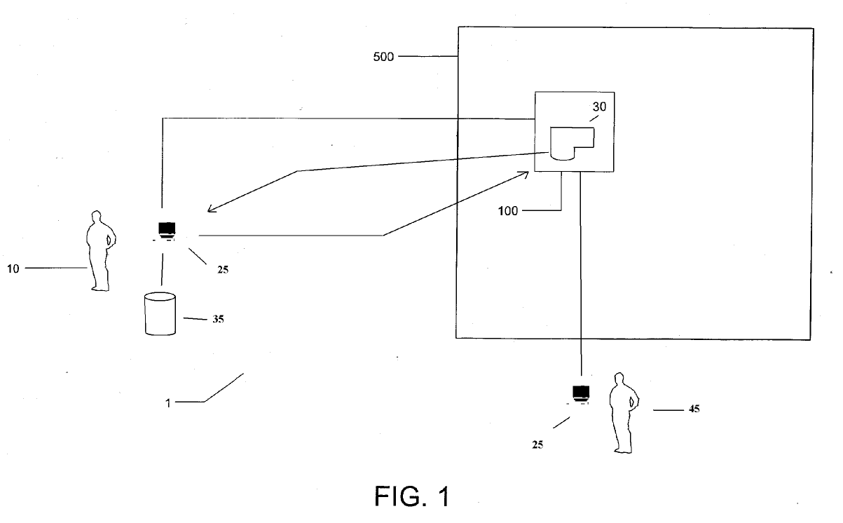

FIG. 1 illustrates a functional diagram of how a User 10 sends and receives E-mail 75 from a computer 25 connected to the Internet 500. The computer 25 can be connected directly through a communication means such as a local Internet Service Provider, often referred to as ISPs, or through an on-line service provider like CompuServe, Prodigy, American Online, etc.

The Users 10 contacts the Internet 500 using an informational processing system capable of running an HTML compliant Web browser such as Microsoft's Internet Explorer, Netscape Navigator, Lynx, and Mosaic. A typical system that is used is a personal computer with an operating system such as a Windows variant or Linux or Mac OS, running a Web browser. The exact hardware configuration of computer used by the User 10, the brand of operating system, or the brand of Web browser configuration is unimportant to understand this present invention. Those skilled in the art can conclude that any HTML (Hyper Text Markup Language) compatible Web browser is within the true spirit of this invention and the scope of the claims.

In one preferred embodiment of the invention, the User 10 connects to the Internet 500. The User 10 creates E-Mail messages 30 using a standard E-mail system 35 such as AOL, Microsoft Outlook, or Hotmail. Once created the User 10 hits the send or completed key. The E-mail system 35 sends the E-Mail messages 30 through the Internet 500 to the E-Mail Server 100 where it is redirected to the receiver 40. The E-mail server 100 handles thousands and thousands of such requests. Sender 45 uses the same previously mentioned method to send an E-Mail 30 to the User 10. The User's 10 system 35 tells the user 10 that he/she has an E-mail message 30 waiting for him/her.

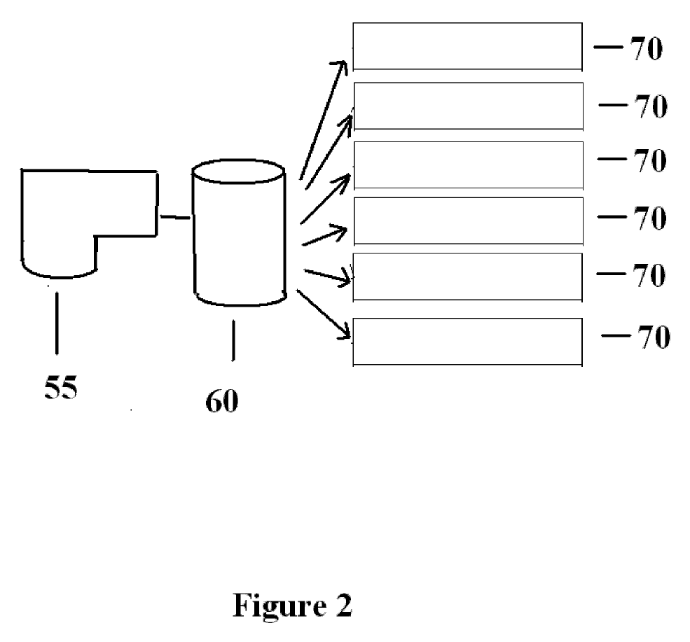

FIG. 2 shows how E-mail messages 30 are spammed. There are several methods that a spammer system 55 works. One of the methods is for the spammer system 55 to have a database of multiple E-mail addresses 60. These E-mail addresses 60 are either purchased or recorded for website transactions. The spammer system 55 sends out repetitive E-mail messages 30 to each of the E-mail addresses 70 on the database 60. Sometimes the spammer system 55 will send out multiple E-mail messages 30 to the same E-Mail address 70 each promoting either the same or a different message or service. Another method of spamming is for the spamming system 55 to send a single message 30 to the E-mail server 100 with instructions that cause the E-Mail server 100 to duplicate the E-Mail message 30 to all of the users 10 of that E-mail server 100.

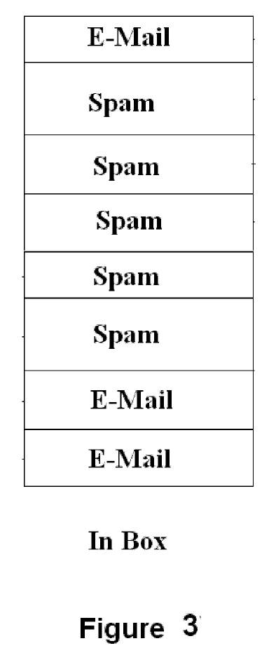

FIG. 3 displays how a typical E-mail inbox is quickly filled up with spammed messages 75. The spammed messages 75 soon outnumber the non-spammed messages 80. This becomes more and more of a problem the longer the user 10 has that E-mail address 65 as that address may be passed along to all of the spamming systems 55.

The current invention's firewall 85 intercepts any incoming email sent to the user 10 and checks it against a master list of allowed senders 45. Any sender 45 not found on the list is sent a user configurable challenge that must be responded to within a set time limit. If the challenge is not successfully met, the sender can be blocked and the E-mail can be bounced, discarded, or sent a removal request.

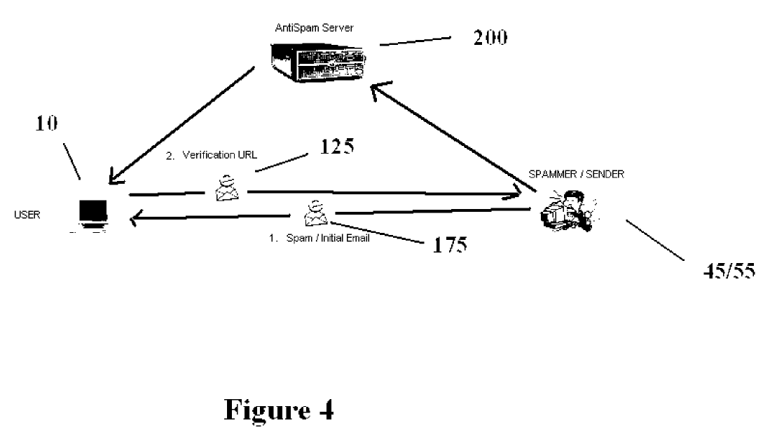

FIG. 4 displays the flow of the prior art anti-spam system. The spammer 55 or sender 45 sends an E-mail to the User 10. The anti-spam system 1 will send a verification URL 125 back to the spammer 55 or sender 45. The spammer 55 or sender 45 will click on the validation link which will connect them to an anti-spam server 200. The anti-spam server 200 will determine whether or not to authorize the E-mail 75. If the anti-spam server 200 authorizes it, then the E-mail is forwarded on to the User 10. If the anti-spam server 200 does authorize the E-mail, then the E-mail is returned to the sender.

The current invention is a distributed challenge and response recognition system that requires no central server, only a user-run client and allows for any type of user-set challenge. The system 1 allows a User 10 to set up their own unique challenges to senders 45 who are attempting to send them an E-mail. The challenges include, but are not limited to: true/false questions, multiple-choice questions, fill in the blank, simple Q&A, active puzzles and picture recognition. As the user 10 can define his or her own unique challenge, based literally upon any source with any possible answer, there is no known method of automating or cracking the authentication protocol.

The system 1 allows each user to have an individual, unique and personalized challenge. There are no limits as to what can be used for a challenge making for endless challenges and answers that are impossible to automate.

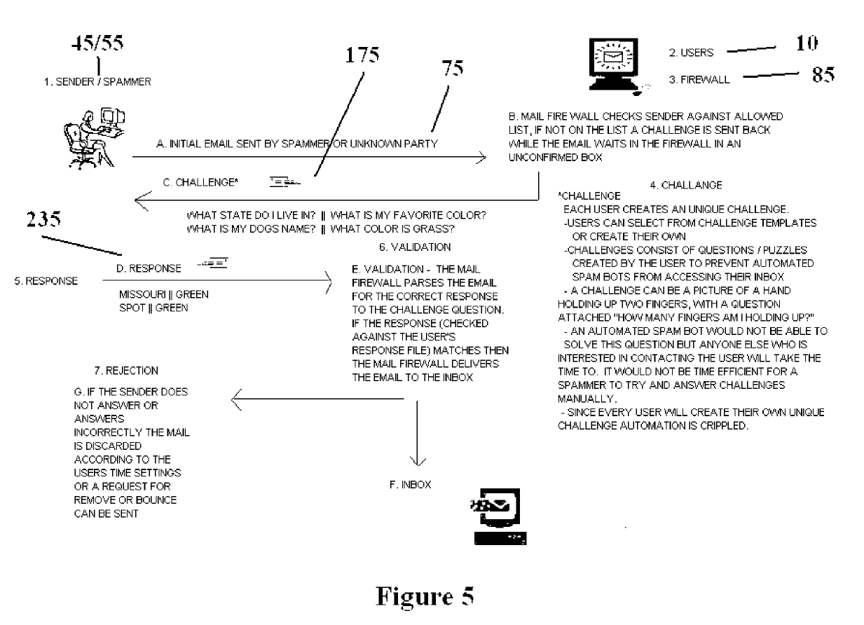

The flow of the system 1 is shown in FIG. 5. The Sender 45 or Spammer 55 sends an E-mail 75 to the User 10. In the preferred embodiment, the system 1 uses a firewall 85. The firewall 85 checks the sender 45 against an allowed list. If the sender 45 is not on the list, a challenge 175 will be sent by the firewall 85 to the sender. The challenge can be anything such as questions like “What State do I live in?”, “What is my favorite color?”, “What is my dog's name?”, and “What college did I go to?” There can even be more than one challenge question. The user 10 would control the answers to these questions and the answers do not have to match the questions. For example, the answer for what is my favorite color could be telephone. The challenges can consist of questions, puzzles or visuals created by the User 10 to prevent automated spam bots from accessing their E-mail inbox.

The system 1 will have a template of challenges that a User 10 can use. The user 10 can also set up their own challenges 175. A challenge 175 can be a picture of a hand holding up two fingers with a question attached “How many fingers am I holding up?” An automated spam bots would not be able to solve this question but anyone else who is interested in contacting the user 10 will take the time to answer the question. With a Spammer interested in dealing with volume, it would not be time efficient for them to try to answer all of the challenges manually. With this system 1, since every user will create their own unique challenges, a spammer's automation is defeated and crippled.

After the sender 45 receives the challenge from the system 1, the sender 45 can response to the challenge 175.

The mail firewall 85 of the system 1 will parse the E-mail response 275 looking for the correct answer to the question. In the preferred embodiment, the system 1 will parse the response 275 at a specific location. This prevents a sender 45 from placing a large number of words in the response 275 in an attempt to guess the correct answer. If the response 275 matches the correct answer to the question, then the system 1 will deliver the E-mail 75 to the inbox or any other folder of the user 10 or even with an awaiting confirmation status to be set up at the User's 10 option. If the response 175 does not have the correct answer, then the system 1 can generate a rejection 375 back to the sender 45. At the option of the user 10, the E-mail message 75 can be sent back to the sender 45.

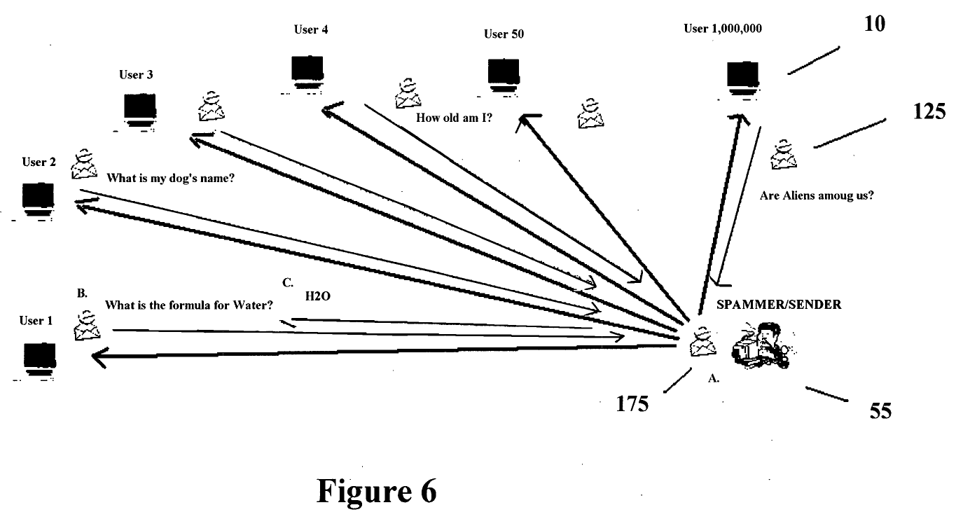

FIG. 6 displays how the system 1 will work with multiple users 10. The spammer 55 will send multiple spam E-mail messages out to Users 10 with each user's system 1 responding with their own unique response 175.

In the preferred embodiment, the program and its routines will be written in C++ language, however, the program can be written in any standard programming language.

### Alternative Embodiments

In an alternative embodiment, the System 1 could also be used in a Wireless cell phone environment.

Advantages

Although the present invention has been described in considerable detail with reference to certain preferred versions thereof, other versions are possible. Therefore, the point and scope of the appended claims should not be limited to the description of the preferred versions contained herein.

As to a further discussion of the manner of usage and operation of the present invention, the same should be apparent from the above description. Accordingly, no further discussion relating to the manner of usage and operation will be provided.

With respect to the above description, it is to be realized that the optimum dimensional relationships for the parts of the invention, to include variations in size, materials, shape, form, function and manner of operation, assembly and use, are deemed readily apparent and obvious to one skilled in the art, and all equivalent relationships to those illustrated in the drawings and described in the specification are intended to be encompassed by the present invention.

Therefore, the foregoing is considered as illustrative only of the principles of the invention. Further, since numerous modifications and changes will readily occur to those skilled in the art, it is not desired to limit the invention to the exact construction and operation shown and described, and accordingly, all suitable modifications and equivalents may be resorted to, falling within the scope of the invention.

That which is claimed is:

1. A system for blocking unauthorized received messages;
having a sender send a message to a user;
sending said sender a challenge;
reviewing a response to said challenge if said response is correct then forward said message to said user's inbox.

2. A system according to claim 1 wherein said system has a firewall.

3. A system according to claim 2 which includes the step of having said firewall comparing said sender to an allowed list.

4. A system according to claim 3 which includes the step of having said firewall forward said message to said user's inbox if sender is on said allowed list.

5. A system according to claim 1 where said response is parsed to see if it has the correct answer.

6. A system according to claim 1 where said message is deleted if said response does not have the correct answer.

7. A system according to claim 1 where templates of challenges are provided to said user.

8. A system according to claim 1 where said user creates their own challenge.

9. A system according to claim 1 where a rejection is send to said sender if said response does not have the correct answer.

10. A system according to claim 1 where said message is sent over a wireless environment.

11. A system for blocking unauthorized received E-mail messages;
having a sender send a message to a user;
sending said sender a challenge;
reviewing a response to said challenge if said response is correct then forward said message to said user's inbox.

12. A system according to claim 11 wherein said system has a firewall.

13. A system according to claim 12 which includes the step of having said firewall comparing said sender to an allowed list.

14. A system according to claim 13 which includes the step of having said firewall forward said message to said user's inbox if sender is on said allowed list.

15. A system according to claim 11 where said response is parsed to see if it has the correct answer.

16. A system according to claim 11 where said message is deleted if said response does not have the correct answer.

17. A system according to claim 11 where templates of challenges are provided to said user.

18. A system according to claim 11 where said user creates their own challenge.

19. A system according to claim 11 where a rejection is send to said sender if said response does not have the correct answer.

20. A system according to claim 15 where a single location of said response is parsed to see if it has the correct answer.
